(19) United States
(12) Patent Application Publication
(10) Pub. No.: US 2010/0090382 A1
(43) Pub. Date: Apr. 15, 2010

(54) TORSIONAL VIBRATION DAMPER ARRANGEMENT

(75) Inventors: Cora Carlson, Dittelbrunn (DE); Andreas Orlamünder, Schonungen (DE); Thomas Dögel, Bad Kissingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/520,423

(22) PCT Filed: Dec. 4, 2007
(86) PCT No.: PCT/EP2007/010505

§ 371 Date: Jun. 19, 2009

(30) Foreign Application Priority Data
Dec. 22, 2006 (DE) 10 2006 061 342.2

(51) Int. Cl. F16F 9/08

(52) U.S. Cl. 267/140.13

(57) ABSTRACT

A torsional vibration damper arrangement, includes a primary side and a secondary side coupled to the primary side via a damper fluid to rotate about a rotational axis relative to each other. The damper fluid arrangement includes a first damper fluid, in a first damper fluid chamber arrangement, which transmits a torque between the primary side and the secondary side, and a second damper fluid, in a second damper fluid chamber, which is loaded when the pressure of the first damper fluid in the first damper fluid chamber is increased. The second damper fluid chamber arrangement includes a cylindrical chamber units arranged radially outside and/or radially inside in relation to the first damper fluid chamber arrangement and one after the other in the circumferential direction, a separating element separating the first damper fluid from the second damper fluid and being displaced radially when the pressure in the chamber unit changes.

### PRIORITY CLAIM

This is a U.S. national stage of application No. PCT/EP2007/010505, filed on 4 Dec. 2007, which claims Priority to the German Application No.: 10 2006 061 342.2, filed: 22 Dec. 2006; the contents of both being incorporated herein by reference.

### BACKGROUND OF THE INVENTION

1. Field of the Invention

The present invention pertains to a torsional vibration damper arrangement, especially for the drive train of a motor vehicle, comprising a primary side and a secondary side, the secondary side being connected to the primary side for rotation around an axis of rotation and for relative rotation of the two sides with respect to each other by a damper fluid arrangement.

2. Prior Art

The subsequently published German Patent Application 10 2005 058 531 discloses a torsional vibration damper in which the elasticity required for the damping of vibrations is provided by a damper fluid arrangement, which comprises an essentially incompressible first damper fluid such as a liquid and a compressible second damper fluid, i.e., a gaseous medium. The first, incompressible damper fluid is present in pressure chambers, the volumes of which change upon relative rotation between the primary side and the secondary side. When the volume decreases, first damper fluid is displaced from these pressure chambers into connecting chambers located radially outside of them. Each connecting chamber is separated by a circumferentially displaceable separating piston from a compensating chamber, which is located radially outside each of the pressure chambers, extends essentially in the circumferential direction, and contains second damper fluid. When the first damper fluid is displaced from the pressure chamber, the separating piston is displaced by the increased volume of the first damper fluid in the connecting chamber, the effect of which is to compress the second damper fluid.

### SUMMARY OF THE INVENTION

A goal of the present invention is to provide a torsional vibration damper arrangement which, while making efficient use of the available space, offers improved vibration-damping behavior.

According to one embodiment of the invention, this goal is achieved by a torsional vibration damper arrangement, especially for the drive train of a motor vehicle, comprising a primary side and a secondary side, the secondary side being connected to the primary side for rotation around an axis of rotation and for relative rotation of the two sides with respect to each other by a damper fluid arrangement,

where the damper fluid arrangement comprises a first damper fluid of lesser compressibility in a first damper fluid chamber arrangement to transmit torque between the primary side and the secondary side and a second damper fluid of higher compressibility in a second damper fluid chamber arrangement, the second damper fluid being put under load when the pressure of the first damper fluid in the first damper fluid chamber arrangement increases;

where the second damper fluid arrangement comprises a plurality of preferably essentially cylindrical chamber units, which are arranged in a row around the circumference radially outside and/or radially inside the first damper fluid arrangement;

where a separating element, which separates the first damper fluid from the second damper fluid and which can be displaced essentially in the radial direction when the pressure in the chamber unit changes, is assigned to each chamber unit.

In the inventive torsional vibration damper arrangement, the chamber units of the second damper fluid chamber arrangement, i.e., those volumes which contain the second damper fluid, which is essentially compressible so as also to fulfill a vibration-damping functionality, are arranged so that they extend essentially in the radial direction, where this orientation of the arrangement also corresponds to the direction of movement of the radially displaceable separating elements assigned to the various chamber units. This means, first, that these separating elements can execute essentially linear movements and do not have to travel along a curved path in the circumferential direction. This is advantageous especially in cases where these types of separating elements are designed as separating pistons, which are displaced in correspondence with the pressure relationships. Second, the inventive positioning or orientation of the chamber units makes it possible to use the available space very efficiently, especially in the radial direction, which makes it possible in turn to provide a comparatively large reservoir for the second damper fluid.

For example, it can be provided that the first damper fluid chamber arrangement is designed with a ring-like structure, and that the chamber units of the second damper fluid chamber arrangement are arranged with a star-like configuration around the axis of rotation with respect to the first damper fluid chamber arrangement. It should be noted here that, insofar as a star-like configuration or a sequence in the circumferential direction is discussed, this obviously also includes the possibility that the chamber units following each other in the circumferential direction can also be offset from each other in the axial direction and can overlap partially in the circumferential direction.

Especially when there is a comparatively large amount of space available in the radially outer area, it is advantageous for the chamber units of the second damper fluid chamber arrangement to be arranged radially outside the first damper fluid chamber arrangement.

In an alternative embodiment, which is very compact especially in the radial direction, the chamber units of the second damper fluid chamber arrangement are arranged radially inside the first damper fluid chamber arrangement.

The design of the inventive torsional vibration damper arrangement can also be such that the first damper fluid chamber arrangement comprises at least one first pressure chamber, the volume of which can be decreased upon relative rotation of the primary side relative to the secondary side in a first direction of relative rotation, and which is in working connection with at least one of the assigned chamber units of the second damper fluid chamber arrangement by way of a connecting chamber.

To provide a damping functionality both in the pull direction, that is, upon the transmission of torque from the primary side to the secondary side, as well as in the push direction, i.e., upon the transmission of torque from the secondary side to the primary side, it is also proposed that the first damper fluid chamber arrangement comprise at least one second pressure chamber, the volume of which can be reduced upon relative rotation of the primary side relative to the secondary side in a direction of relative rotation opposite the first direction of relative rotation, and which in working connection with at least one of the assigned chamber units of the second damper fluid arrangement by way of a connecting chamber.

A very efficient radial staggering can be obtained in that the at least one first pressure chamber and/or the at least one second pressure chamber extend in the circumferential direction, and in that the connecting chamber assigned to this chamber is located on the same radial side as that on which the second damper fluid chamber arrangement is located relative to the first damper fluid chamber arrangement. This means essentially that the connecting chambers are always located radially between the pressure chambers of the first damper fluid chamber arrangement and the chamber units of the second damper fluid chamber arrangement.

To arrive at the previously mentioned ring-like structure of the pressure chambers, i.e., of the first damper fluid chamber arrangement, it is proposed that one side, i.e., either the primary side or the secondary side, comprises a first essentially cylindrical chamber housing and that the other side, i.e., the secondary side or the primary side, comprise a second cylindrical chamber housing, which is inserted into the first cylindrical chamber housing and cooperates with it to form the boundaries of an annular space, where at least one first circumferential boundary projection extending toward the second chamber housing is provided on the first chamber housing, and at least one second circumferential boundary projection extending toward the first chamber housing is provided on the second chamber housing, where a pressure chamber is bounded in the circumferential direction between each first circumferential boundary projection and a second boundary projection, and where the volume of the pressure chamber is variable by means of the relative circumferential movement of the circumferential boundary projections forming the boundaries of this chamber.

When a damping functionality is provided in both the push direction and in the pull direction, the effective volume of the second damper fluid chamber arrangement, i.e., of the second damper fluid, can be increased in that at least one chamber unit of the second damper fluid chamber arrangement assigned to a first pressure chamber of the first damper fluid chamber arrangement is in pressure-equalization connection with at least one other chamber unit of the second damper fluid chamber arrangement which is assigned to a second pressure chamber of the first damper fluid chamber arrangement. At least some of the chamber units are then double-acting; that is, they act both in the pull direction and in the push direction.

According to one embodiment of the invention, the number of chamber units of the second damper fluid chamber arrangement assigned to a first pressure chamber of the first damper fluid chamber arrangement differs from the number of chamber units of the second damper fluid chamber arrangement assigned to a second pressure chamber of the first damper fluid arrangement. In this way, it is possible to make the vibration-damping behavior in the pull direction different from that in the push direction.

In one embodiment, the number of the chamber units of the second damper fluid chamber arrangement assigned to a first pressure chamber of the first damper fluid chamber arrangement is different than the number of the chamber units of the second damper fluid chamber arrangement assigned to another first pressure chamber of the first damper fluid chamber arrangement and/or for the number of the chamber units of the second damper fluid chamber arrangement assigned to a second pressure chamber of the first damper fluid chamber arrangement is different than the number of the chamber units of the second damper fluid chamber arrangement assigned to another second pressure chamber of the first damper fluid chamber arrangement.

To provide a desired damping characteristic, it is advantageous to provide a comparatively large volume for the second damper fluid. A volume expansion area for the second damper fluid is assigned to at least one chamber unit of the second damper fluid chamber arrangement. The volume area expansion comprises the volume enclosed between two circumferentially adjacent chamber units of the second damper fluid chamber arrangement. As a result, there is no need to provide any additional radial space for these types of volume expansions.

So that the damping behavior can be subjected to further influence, it is proposed that the first damper fluid chamber arrangement be or be bringable into connection with a source and/or a reservoir for the first damper fluid by means of a rotary leadthrough.

### BRIEF DESCRIPTION OF THE DRAWINGS

The present invention is described in greater detail below on the basis of the attached drawings:

FIG. 1 is a longitudinal cross section through an inventively designed torsional vibration damper arrangement;

FIG. 2 is a cross-sectional view of the arrangement of FIG. 1 along line II-II in FIG. 1;

FIG. 3 is a partial cross-sectional view, corresponding to FIG. 2, of a modified embodiment;

FIG. 4 is another partial cross-sectional view, corresponding to FIG. 2, of a modified embodiment;

FIG. 5 is a longitudinal cross section through an alternative embodiment of the torsional vibration damper arrangement;

FIG. 6 is a cross-sectional view of the radially inner area of the torsional vibration damper arrangement of FIG. 1;

FIG. 7 is another cross-sectional view, corresponding to FIG. 2, of an alternative embodiment;

FIG. 8 is a longitudinal cross section of the embodiment of FIG. 7;

FIG. 9 is a partial cross-sectional view of two chamber units;

FIG. 10 is the two chamber units of FIG. 9 in a different operating state;

FIG. 11 is a view, corresponding to FIG. 9, of an alternative embodiment;

FIG. 12 is the two chamber units of FIG. 11 in a different operating state;

FIG. 13 is another view, corresponding to FIG. 9, of an alternative embodiment; and

FIG. 14 is another view, corresponding to FIG. 9, of an alternative embodiment.

### DETAILED DESCRIPTION OF THE DRAWINGS

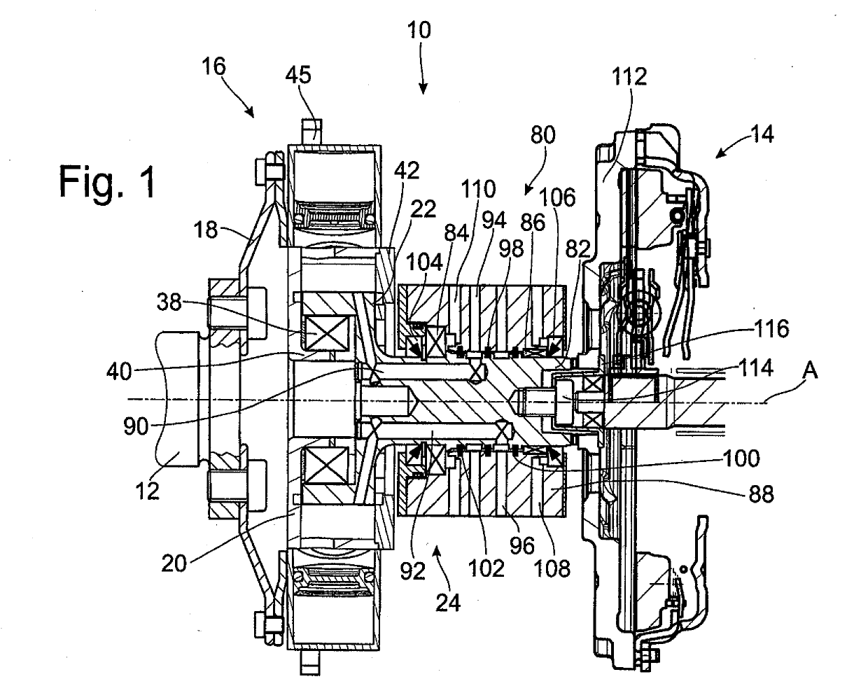

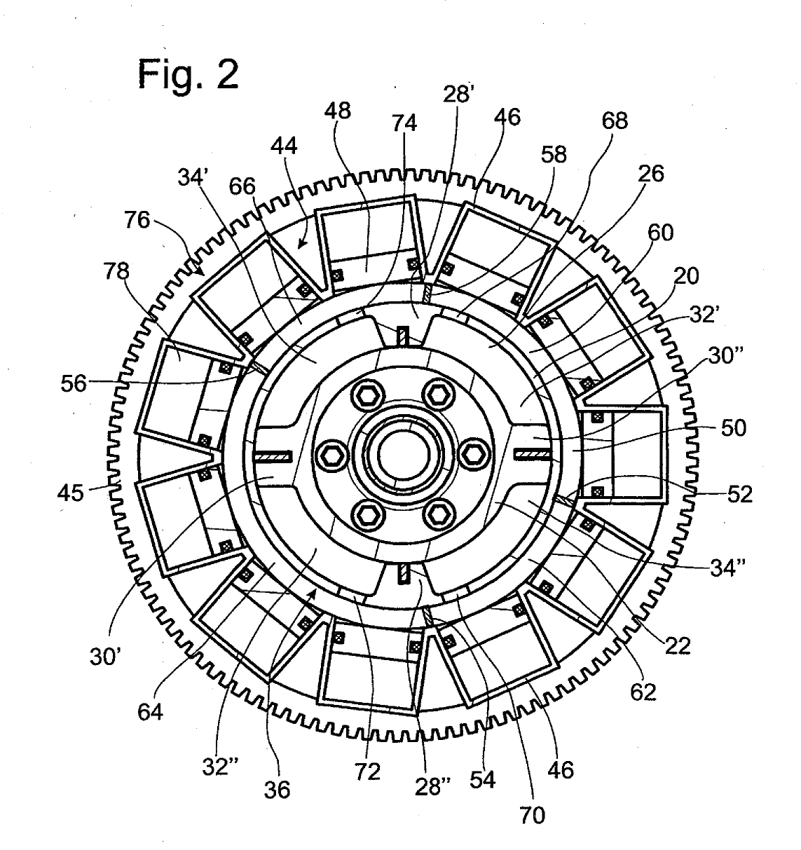

FIGS. 1 and 2 show a first embodiment of a torsional vibration damper arrangement 10. This serves to transmit torque in the drive train of a motor vehicle between a drive shaft 12 rotating around an axis of rotation A, i.e., a crankshaft, for example, and a friction clutch 14. With respect to the following explanations, a “pull” state is discussed wherein torque is transmitted from the drive shaft 12 to the friction clutch 14. A “push” state is discussed wherein the torque is being transmitted from the friction clutch 14 toward the drive shaft 12, i.e., for example, when the vehicle is operating in an engine-braking state.

The torsional vibration damper arrangement 10 comprises a primary side, designated overall by the number 16. This is connected to the drive shaft 12 by a flexplate arrangement 18, which integrates an elasticity into the drive train to compensate for wobbling movements and axial misalignments. As can be clearly seen in FIG. 1, the flexplate arrangement 18 is designed such that its radially inner area is connected to the drive shaft 12, whereas its radially outer area is connected to the primary side 16, so that there is no need to take special measures in the radially inner area of the torsional vibration damper arrangement 10 to connect it to the drive shaft 12.

The primary side 16 comprises an essentially ring-like first chamber housing 20. Into this housing, a second chamber housing 22 of a secondary side 24 of the torsional vibration damper arrangement 10 is inserted coaxially. The second housing is preferably of a ring-like design. As shown in FIG. 2, a ring-like intermediate space 26 is formed between the two chamber housings 20, 22. On the first chamber housing 20, two radially inward-pointing circumferential boundary projections 28′ and 28″, spaced 180° apart, are provided. In a corresponding manner, two radially outward-pointing circumferential boundary projections 30′ and 30″, again spaced 180° apart, are provided on the second chamber housing 22. The circumferential boundary projections 28′, 28″, 30′, 30″, each of which points toward the opposite chamber housing, form the boundaries of first pressure chambers 32′ and 32″ and second pressure chambers 34′, 34″ of a first damper fluid chamber arrangement, designated overall by the number 36. By means of sealing elements provided on the individual circumferential boundary projections 28′, 28″, 30′, 30″, the first and second pressure chambers 32′, 34″, 32″, 34′ alternate in the circumferential direction and are separated from each other in an essentially fluid-tight manner. The pressure chambers 32′, 32″, 34′ and 34″ are also closed off in a fluid-tight manner in the axial direction by the first chamber housing 20 and a cover plate 42 permanently connected to it in cooperation with the second chamber housing 22 and the sealing elements provided thereon. As a result of the ability of the primary side 16 of the torsional vibration damper arrangement 10 to rotate around the axis of rotation A relative to the secondary side 24, the volumes of the pressure chambers 32′, 32″, 34′ and 34″ are variable. When, for example, the inner chamber housing 22 rotates relative to the outer chamber housing 20 in the counterclockwise direction in FIG. 2, the volumes of the second pressure chambers 34′ and 34″ increase, whereas the volumes of the first pressure chambers 32′ and 32″ decrease.

So that this relative rotational movement is possible in a defined manner, a radial bearing 38, as shown in FIG. 1, is arranged between the inside circumference of the second chamber housing 22 and an extension 40 of the first chamber housing 20, which projects radially inward over the second chamber housing. This bearing 38 is preferably designed as a bearing with rolling elements or as a plain bearing. The bearing can also serve to provide axial support.

Radially on the outside, the first chamber housing 20 is surrounded by a chamber unit assembly 44. This chamber unit assembly 44, preferably fabricated as a single part comprises a plurality of cup-like chamber units 46, which follow each other around the circumference in a row around the axis of rotation A. Radially on the outside, a starter gear ring 45 is provided as a separate component on the chamber unit assembly 44; this gear ring is permanently connected by welding, for example, to the radially outer area of the various chamber units 46. With respect to the axis of rotation A, the chamber units 46 are arranged in a radially outward-projecting, star-like configuration and are open radially on the inside. Into each of these chamber units 46, a separating piston 48 is inserted, which is closed off in a fluid-tight manner against the associated chamber unit 46 by an O-ring-like sealing element and is free to move back and forth essentially in the radial direction inside this unit. Radially on the inside, the chamber units 46 are open to an annular space 50. This space is divided in the circumferential direction by several separating walls 52, 54, 56, 58. These separating walls 52, 54, 56, 58 divide the annular space 50 into four connecting chambers 60, 62, 64, 66. Each of these connecting chambers 60, 62, 64, 66 is assigned to one of the pressure chambers 32′, 34″, 32″, or 34′. It can be seen that openings 68, 70, 72, 74 are present in the radially outer area of the chamber housing 20. The opening 68 provides a connection between the first pressure chamber 32′ and the radially outward-lying connecting chamber 60. The opening 70 establishes a connection between the second pressure chamber 34″ and the radially outward-lying connecting chamber 62. The opening 72 establishes a connection between the first pressure chamber 32″ and the radially outward-lying connecting chamber 64, and the opening 74 establishes a connection between the second pressure chamber 34′ and the radially outward-lying connecting chamber 66.

By way of these connecting chambers 60, 62, 64, 66, the various pressure chambers 32′, 32″, 34′, 34″ are connected to the assigned chamber units 46 of a second damper fluid chamber arrangement designated overall by the number 76. It can be seen that, as a result of the positioning of the separating walls 58 and 52 of the first pressure chamber 32′, three chamber units 46, following each other directly in the circumferential direction, are assigned to the first pressure chamber 32′ by way of the connecting chamber 60. Four of the chamber units 46 are assigned to the first pressure chamber 32″ via the connecting chamber 64. Two chamber units 46 are assigned to the second pressure chamber 34′ via the connecting chamber 66, and also two of the chamber units 46 are assigned to the second pressure chamber 34″ by way of the connecting chamber 62.

The volumes 78 of the chamber units 46, which are closed off in a fluid-tight manner by the separating pistons 48 in the radially inward direction toward the annular space 50 and/or the connecting chambers 60, 62, 64, 66, are filled with a compressible damper fluid, for example, a gas, such as air. Like the connecting chambers 60, 62, 64, 66, the pressure chambers 32′, 32″, 34′ and 34″ are filled with an essentially incompressible damper fluid, a liquid such as an oil or the like.

So that the pressure chambers 32′, 32″, 34′, and 34″ and the connecting chambers 60, 62, 64, 66 can be filled with the incompressible damper fluid, a rotary leadthrough, designated overall by the number 80, is assigned to the secondary side 24. This leadthrough comprises a rotary leadthrough ring 88, which surrounds an axial extension 82 of the chamber housing 22, and which is supported by two bearing units 84, 86 so that it can rotate relative to this extension. In the chamber housing 22, channels 90, 92 are formed by bores, the channel 90 leading, for example, to the second pressure chambers 34′, 34″, whereas the channel 92 leads to the first pressure chambers 32′, 32″. To minimize the flow losses, in one embodiment, each of the pressure chambers to be supplied by its own separate channel. In the rotary leadthrough ring 80, a channel 94, 96, which remains stationary during rotational operation, is assigned to each of these channels. Via the channels 94, 96, the channels 90, 92 are brought into connection with a source of the incompressible damper fluid or a reservoir of such fluid. In this way, the fluid pressure of the incompressible damper fluid in the pressure chambers 32′, 32″, 34′, and 34″ can be adapted appropriately to the required damping characteristic.

In FIG. 1, sealing elements 98, 100, and 102, which represent pressure seals, are present on both sides of the channels 94, 96 in the rotary leadthrough ring 88. Axially outside each of the bearings 84 and 86 volume flow seals 104, 106 are arranged. The volumes formed between the seals 100 and 106 on the one side and the seals 102, 104 on the other is preferably drained via individual leakage channels 108, 110, so that any incompressible damper fluid, which may have gotten past the pressure seals, can be conducted back to the reservoir.

The friction clutch 14 is of conventional design and is designed in the radially inner area of the flywheel 112 with serrations, which mesh with serrations on the axial extension 82 of the chamber housing 22. By means of a clamping screw 114, this intermeshing is retained stably, so that a nonrotatable connection is realized between the friction clutch 14 and the secondary side 24 of the torsional vibration damper arrangement 10. This clamping screw 114 exerts load on the radially inner area of the flywheel 12 by way of a clamping sleeve 116. A transmission input shaft or the like can be radially supported in this clamping sleeve 116 by way of a pilot bearing or the like.

It should be pointed out here that this is only an example of a drive train. It is obvious that, in the case of a hybrid drive, a rotor arrangement of an electric machine could also be connected in this way to the secondary side 24 of the torsional vibration damper arrangement 10. Other assemblies serving to transmit torque such as a hydrodynamic torque converter, a fluid clutch, or the like could also be connected in this way to the secondary side 24 of the torsional vibration damper arrangement 10.

The function of the torsional vibration damper arrangement 10, the structural design of which has been described above on the basis of FIG. 1 and FIG. 2, will be explained in the following.

In the pull state, that is, in a state in which torque is being transmitted from the primary side 12 to the secondary side 24, the secondary side 24 and, in FIG. 2, the chamber housing 22 as well are initially stationary, and the primary side 12 and, in FIG. 2, therefore, the chamber housing 20 as well turn in the counterclockwise direction. This means that the essentially incompressible damper fluid present in the second pressure chambers 34′ and 34″ is displaced from these pressure chambers through the openings 74 and 70 into the assigned connecting chambers 66, 62. As a result of the increasing pressure in the connecting chambers 66, 62, the separating pistons 48 of the chamber units 46 of the second damper fluid chamber arrangement 76 assigned to these connecting chambers 60, 62 are put under load, so that they are pushed radially outward under compression and corresponding pressure elevation of the compressible damper fluid present in the volumes 78. As the compression increases, the counterforce also increases, so that here in fact a spring characteristic is achieved. If the load occurs in the other direction, the first pressure chambers 32′ and 32″ are reduced in volumes, so that the incompressible damper fluid present in them is displaced through the openings 68 and 72 into the assigned connecting chambers 60, 64, and correspondingly the chamber units 46 located radially outside these connecting chambers 60, 64 are put into action. The separating pistons 48 of these chamber units 46 will move radially outward under compression of the compressible damper fluid and now ensure the desired damping characteristic in the push direction.

It can be seen from the preceding description that, through the displacement of the incompressible damper fluid in the first damper fluid chamber arrangement 36 and the corresponding actuation of the separating pistons 48 in the chamber units 46 of the second damper fluid chamber arrangement 76, a damping functionality can be obtained in both the push direction and the pull direction. The damping characteristic in the pull direction will be different from that in the push direction, because a total of four chamber units 46 is acting in the pull direction, whereas a total of seven chamber units 46 is active in the push direction. It can therefore be seen that, simply through the positioning of the separating walls 52, 54, 56, 58, it is possible to select how many of the chamber units 46 of the second damper fluid chamber arrangement 76 will act during operation in push mode and how many in pull mode. An influence can also be exerted on the damping characteristic by assigning different numbers of chamber units 46 to the various first and possibly also to the various second pressure chambers 32′, 32″, 34′, 34″, as can be seen in the case of the first pressure chambers 32′, 32″. So that out-of-balance states are prevented during rotational operation, it is advantageous for the distribution around the axis of rotation A to be as uniform as possible. Of course, the size and number of the chamber units 46 can be adapted to the given requirements. In the example shown here with a total of 11 chamber units 46, the way in which the individual chamber units 46 are separated from each other necessarily means that the working characteristic in the pull direction will be different from that in the push direction. When there is an even number of chamber units 46, an equal number of them can act in the push and pull directions, and therefore a uniform working characteristic will be provided in both load directions.

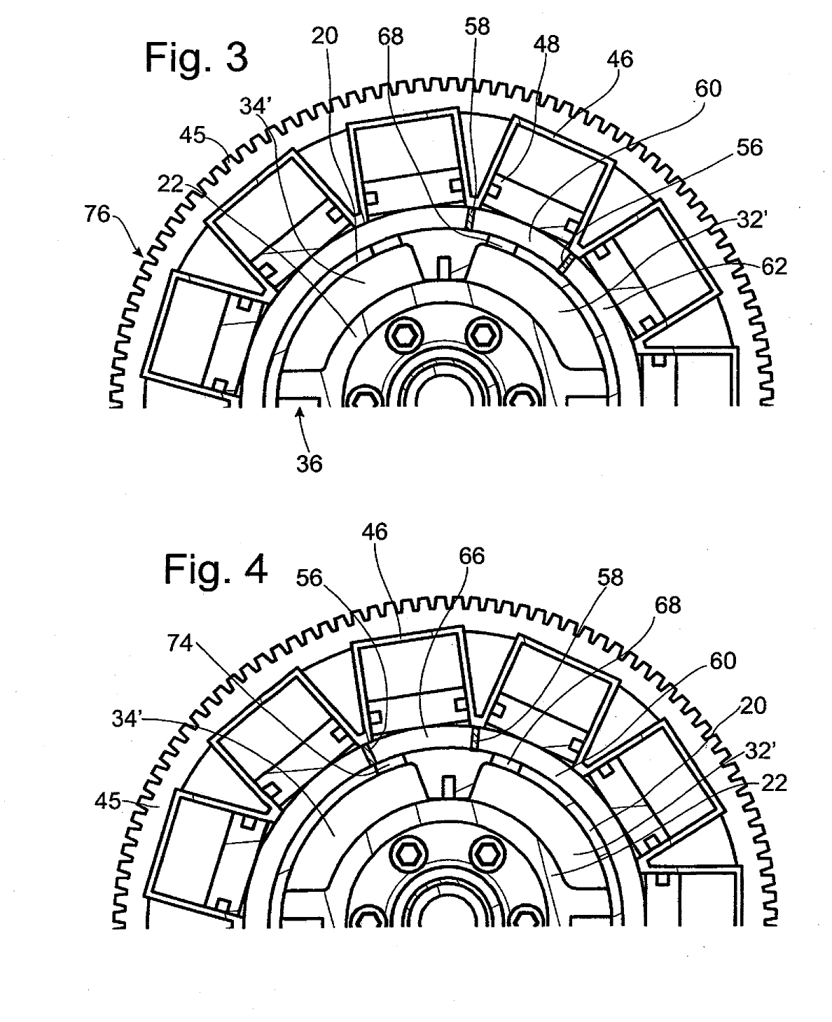

FIGS. 3 and 4 show how the number of chamber units 46 acting in the push and pull directions can be varied. It can be seen in FIG. 3 that the first pressure chamber 32′ has only a single chamber unit 46 assigned to it, which is open radially on the inside to the connecting chamber 60. If the other first pressure chamber 32″ is designed in the same way, a total of two chamber units 46 will then be acting in the push direction, whereas nine chamber units will be acting in the pull direction.

FIG. 4 shows an opposite arrangement, in which only a single chamber unit 46 is assigned to the second pressure chamber 34′ by way of the connecting chamber 66. If the other second pressure chamber 34″ is designed in the same way, only two chamber units 46 will be acting in the pull direction in this arrangement, whereas nine of the total of 11 chamber units 46 will be acting in the push direction.

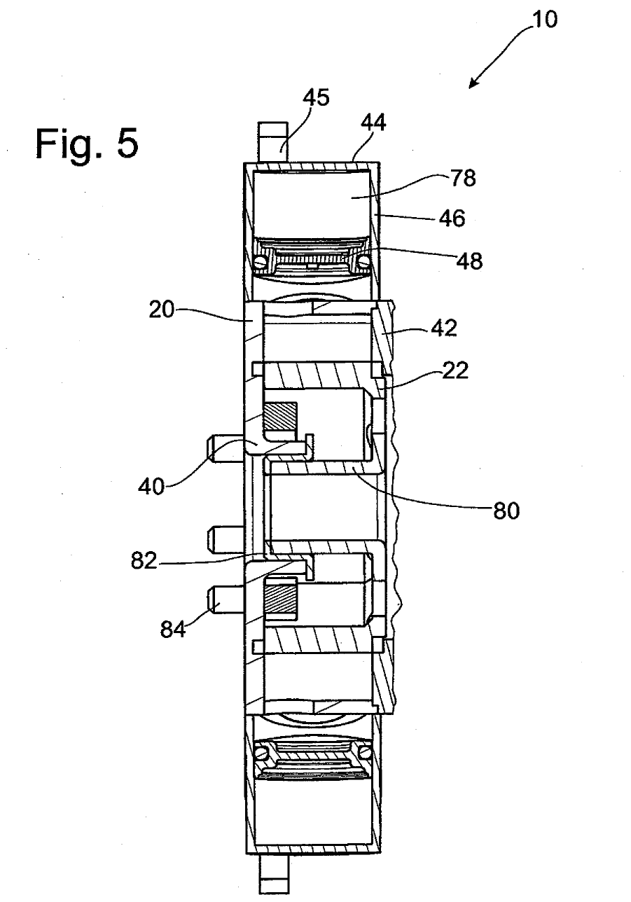

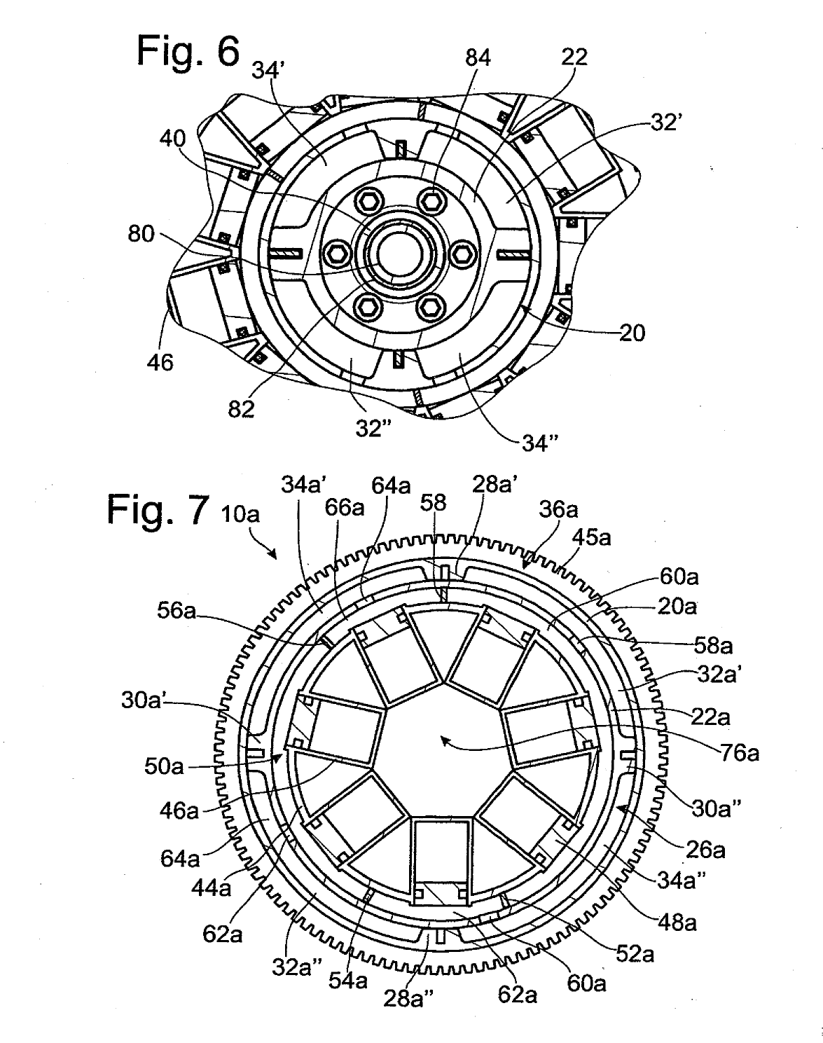

FIGS. 5 and 6 show an embodiment which is different with respect to the mutual support of the two chamber housings 20, 22. The two chamber components 20, 22 comprise ring-like extensions 40 and 80, which overlap axially in the radially inner area. Between them, a sleeve-like or cup-like plain bearing element 82 is inserted. Because of the highly compact design of this plain bearing element 82, there is sufficient space available here in the radially inner area to attach the torsional vibration damper arrangement 10 to the drive shaft 12 by means of a plurality of screw bolts 84. This means, however, that there must be access to the screw bolts 84, especially through the chamber component 22, so that they can be gripped by a tool. An advantage of this variant is that a larger amount of radial space is available for the radially inner chamber component 22.

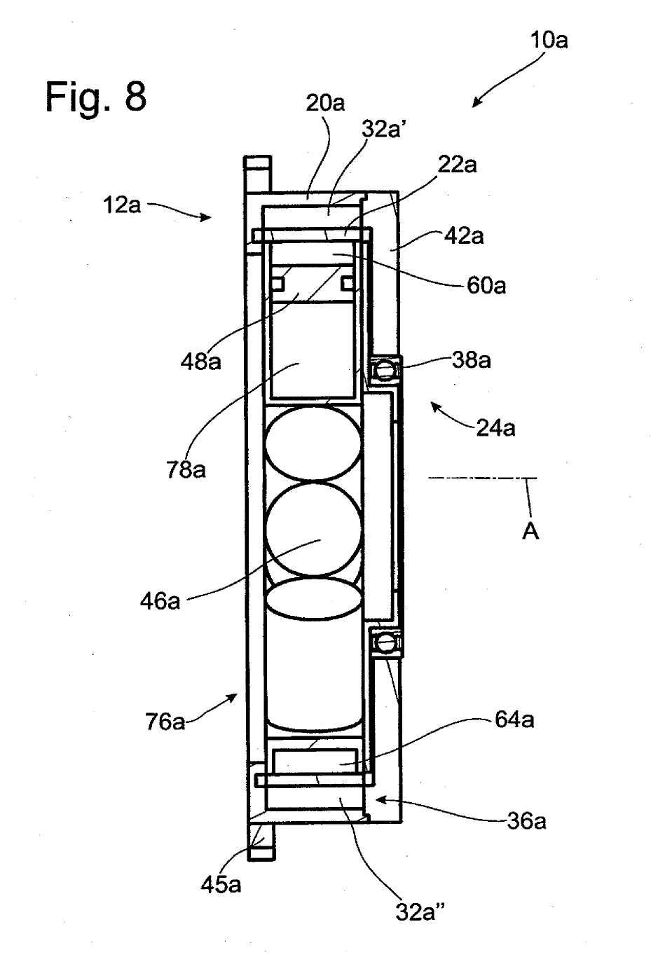

FIGS. 7 and 8 show a modified embodiment. Here the components which are the same with respect to their design and function as those which have already been described above are designated by the same reference numbers plus the letter “a”.

In this embodiment, the chamber units 46a of the chamber unit assembly 44a are arranged radially inside the first damper fluid chamber arrangement 36a with its pressure chambers 32a′, 32a″, 34a′, and 34a″. The connecting chambers 60a, 62a, 64a, 66a are again situated radially between the pressure chambers 32a′, 32a″, 34a′, 34a″ and the chamber unit assembly 44a of the second damper fluid chamber arrangement 76a. This means that, in this variant embodiment, it is essentially the chamber housing 20a, with the gear ring 45a provided on it, which provides the primary side 12a, whereas the chamber housing 22a is now combined into a unit with the chamber unit assembly 44a and forms a component of the secondary side 24a of the torsional vibration damper arrangement 10a. The individual chamber units 46a are again arranged in such a way that they extend essentially in the radial direction, that is, they hold the separating pistons 48a such that they move in the radial direction when they are displaced by the pressure. This star-like configuration, now directed radially inward, has the result that the radially inner ends of the chamber units 46a are located very close to each other, whereas their radially outer areas are separated from each other in the circumferential direction by relatively large gaps. The mutual support between the primary side 12a and the secondary side 24a is realized by a roller bearing 38a, which is arranged radially on the inside between the plate 42a and the chamber housing 22a or a component permanently connected thereto.

A key advantage of this embodiment is that highly efficient use is made of the radially inner space in particular. It is also possible to connect the individual volumes 78a of the chamber units 46a to each other by means of appropriate connecting lines to provide larger total volumes for damping. The essentially incompressible damper fluid, which is present in the various pressure chambers 32a′, 32a″, 34a′, 34a″ and in the connecting chambers 60a, 62a, 64a, 66a assigned to them, can be supplied by way of a rotary leadthrough, which now cooperates with the primary side 12a, that is, for example, with an axial extension of the plate 42a, in a manner such as that described above with respect to FIG. 1.

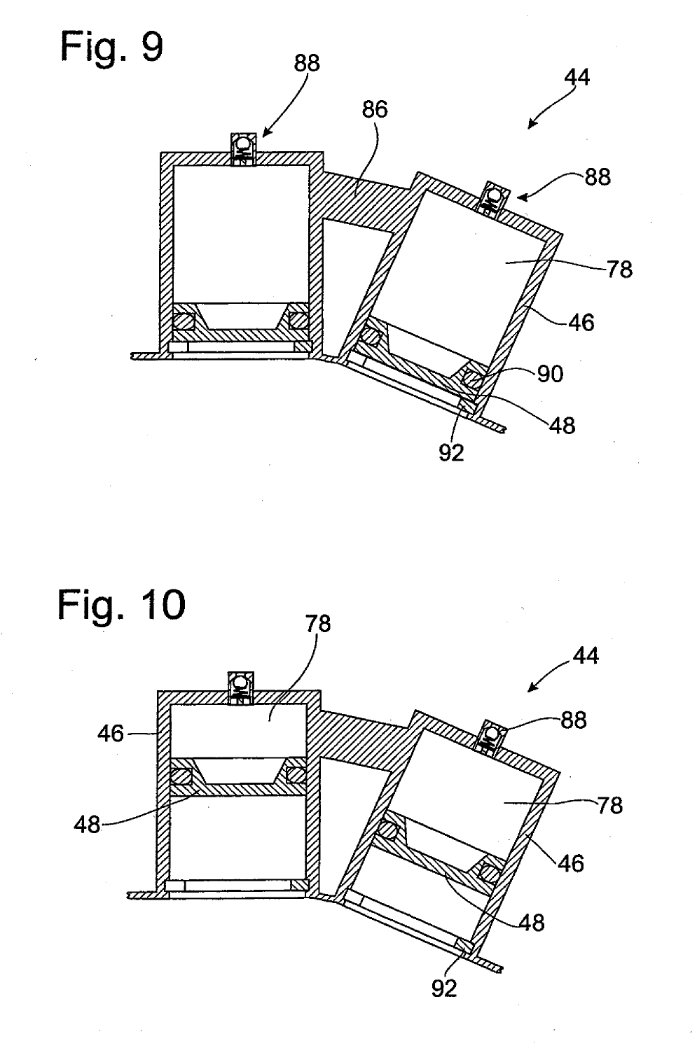

FIG. 9 shows on an enlarged scale a part of the chamber unit assembly 44 used in the torsional vibration damper arrangement 10 described above. Two adjacent chamber units 46 are shown, the radially inner areas of which, i.e., the areas where they are open toward an assigned connecting chamber, are very close together, and they are made as a single, integral component. For stabilization, the radially outer areas of the chamber units are connected to each other by connecting webs 86. In their radially outer bottom wall area, the chamber units 46 are designed with valves 88, through which the compressible damper fluid, e.g., air, is introduced at the desired pressure. These valves 88 can be spring-loaded ball valves or the like.

As shown in the cross-sectional diagram of FIG. 9, the separating pistons 48 are designed such that they comprise a comparatively thin bottom area and have a greater thickness only where an O-ring-like sealing element 90 is accommodated in the circumferential area. In this way, it is possible, first, to minimize the moving weight of the separating piston 48 and, second, to increase the volume of the compressible damper fluid.

Each of the separating pistons 48 is prevented from falling out of the cylindrical chamber units 46 by a locking ring 92, so that, even when the incompressible damper fluid present in an assigned connecting chamber is under little or no pressure, it is ensured that the separating piston 48 has a defined end position.

FIG. 10 is a state in which the chamber units 46 assigned to one and the same connecting chamber and thus to the same pressure chamber are filled with different quantities of the compressible damper fluid, so that different pretensioning pressures prevail. When the pressure builds up in the assigned connecting chamber, the result is that the two separating pistons 48 are displaced to different degrees. The pretensioning pressure of the compressible damper fluid which prevails in the volume 78 of the chamber unit 46 on the left in FIG. 10 is necessarily lower, so that, for the same pressure in the assigned connecting chamber, this separating piston 48 will be pushed farther in than the separating piston 48 of the other chamber unit 46. In this way, it is possible for the various chamber units 46 to go into action in a graduated manner, which results in an appropriately graduated damping behavior in the pull direction, but most desirably also in the push direction. It is therefore possible, for example, to provide low overall stiffness even for the no-load state, whereas, when more powerful torques are being transmitted and/or more pronounced rotational vibrations occur, the chamber units 46 which have been pretensioned to a greater degree with the compressible damper fluid can go into action. Of course, it is also possible, by selecting the appropriate number of chamber units 46, to provide a working characteristic with multiple graduations.

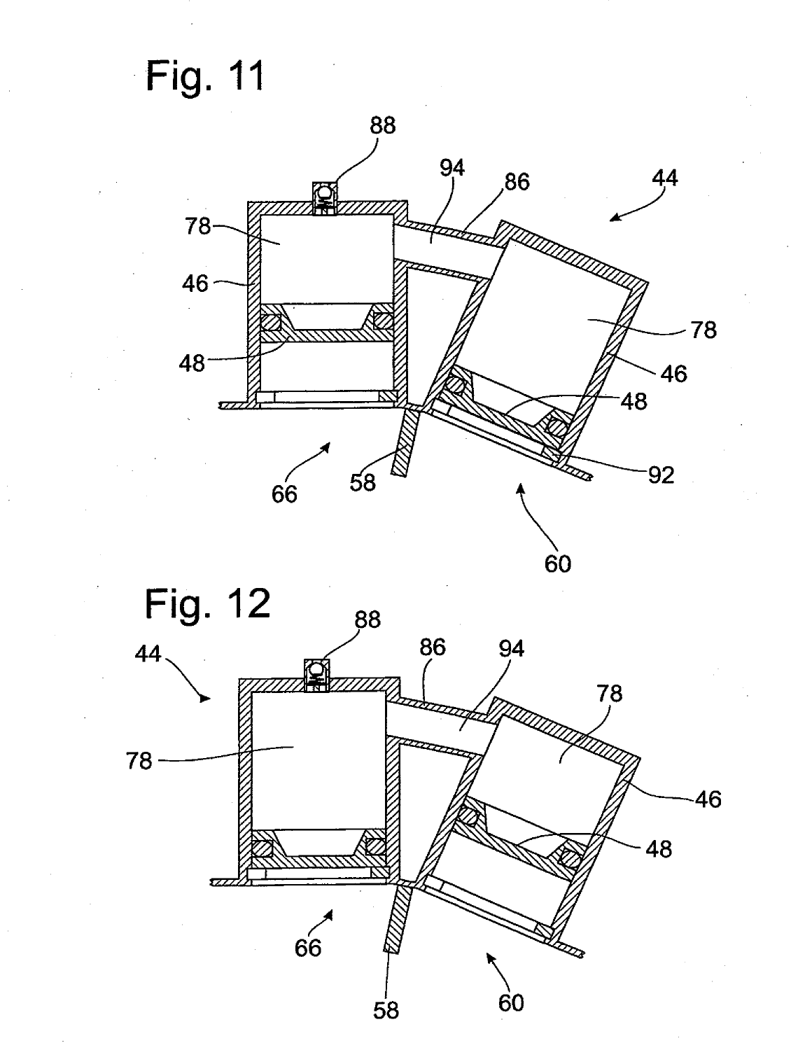

FIG. 11 is an arrangement in which chamber units 46 assigned to two different connecting chambers 60, 66 and thus also to different pressure chambers are connected to each other by a connecting channel 94. The connection between the two volumes 78 results in a larger overall volume, which is active regardless of the direction in which the torque is introduced. FIG. 11 is the state in which a comparatively low pressure of the incompressible damper fluid is present in the connecting chamber 60 and thus also in the assigned pressure chamber 32′, whereas a comparatively high pressure is present in the connecting chamber 66 and thus also in the assigned second pressure chamber 34′, that is, the system is in the pull state. As a result of the higher pressure in the connecting chamber 66, the separating piston 48 of this chamber unit 46, on the left in FIG. 11, is pushed against the pressure of the compressible damper fluid in the two volumes 78 and in the connecting channel 94. That is, both in the pull state and in the push state, the chamber units 46 assigned to the various pressure chambers connected to each other act with their total volumes, which leads accordingly to a decrease in the stiffness of the torsional vibration damper arrangement 10.

FIG. 12 shows the state in which the direction in which the torque is introduced has reversed. Here the pressure in the connecting chamber 60 and in the assigned pressure chamber 32′ is greater than the pressure in the connecting chamber 66 and the assigned pressure chamber 34′. The result of this is that the separating piston 48 in the chamber unit 46, on the right in FIG. 12, is now pushed into chamber unit 46.

Because, in this embodiment, several chamber units 46 and thus their volumes 78 are connected to each other, it is sufficient to provide the valve 88 through which the compressible gaseous damper fluid is supplied to these chamber units 46 on only one of these connected chamber units 46.

The number of chamber units 46 combined with each other to form the total volume in question can be varied as desired. For example, two chamber units 46 of one of the first pressure chambers 32′ and/or 32″ can be connected to one or possibly several of the chamber units 46 of one or more of the second pressure chambers 32′, 34″.

In a corresponding manner it is also obviously possible to connect chamber units 46 together which are assigned to one and the same connecting chamber or to one and the same pressure chamber.

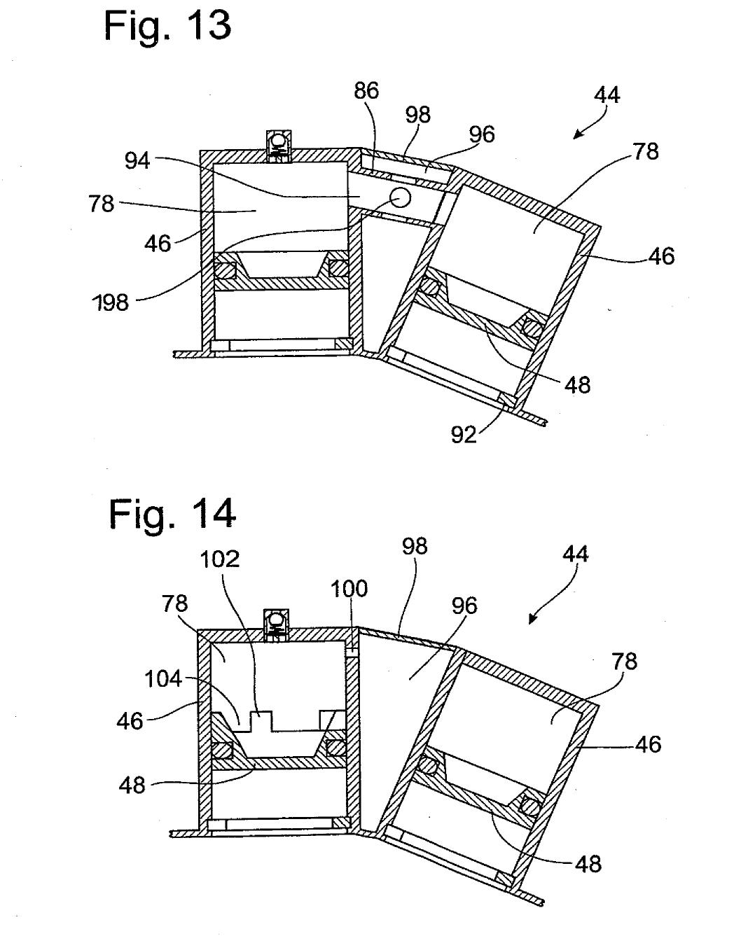

FIG. 13 shows another variant which makes it possible to increase the total volume available for the compressible damper fluid. The volume area 96, which is enclosed between two circumferentially adjacent and essentially radially oriented chamber units 46 with a star-like configuration, tapers down in the radially inward direction, is closed off by a cover wall 198 on the radially outward side, and is obviously closed off in the axial direction by corresponding cover walls (not shown). The connecting web 86 with the channel 94 formed in it therefore extends through this volume area 96. In the connecting channel 94, it is possible to see several openings 198, which are open to the volume area 96, and which therefore bring the volumes 78 of the two chamber units 46 shown and of the channel 94 into connection with the volume area 96. This, too, leads to an increase in the total active volume when the separating pistons 48 are subjected to load by the essentially incompressible damper fluid.

It is obvious that this type of connection, i.e., this type of additional use, of the volume areas 96, can be used for all or for only some of the chamber units 46. Here, as shown in FIGS. 11 and 12, the chamber unit 46 or several of the chamber units 46 connected in this way can cooperate with different connecting chambers and thus with different pressure chambers. Of course, this volume increase can also be provided for the same connecting chamber and thus for the chamber units 46 acting under the same load conditions.

As previously explained above with reference to FIGS. 7 and 8, in cases where the chamber units 46 are arranged in the radially inner area and extend radially inward, use is made of the volume areas lying between adjacent units.

FIG. 14 shows another variant of this. Volume area 96 is between two chamber units 46 directly adjacent to each other in the circumferential direction. The volume area 96 is again sealed off tightly on the radially outward side by the wall 98 and is closed off correspondingly also in the axial direction. No web or channel is provided between these two chamber units 46. Instead, an opening 100 is provided in the circumferential wall of the chamber unit 46 shown on the left. This opening brings the volume 78 of the chamber unit into connection with the volume area 96. Here, therefore, only the volume of the chamber unit 46 shown on the left is increased by the volume area 96. A corresponding connection or action is not produced in the case of the chamber unit 46 shown on the right.

In cases of maximum displacement of the separating piston 48 assigned to the chamber unit 46 shown on the left, preferably the opening 100 does not become blocked, this separating piston 48 comprises several axially projecting spacer webs 102, which face the bottom area of the chamber unit 46 and, because of the openings 104 formed between them, ensure that the opening 100 remains open even at maximum displacement of the separating piston 48.

In the case of the design variant shown in FIG. 14, the additional volume of the volume areas 96 is used not only by one of the adjacent chamber units 46 but also, as shown in FIG. 13, by both of the chamber units 46 forming the boundaries of the volume area 96. Here, in the case of the diagram of FIG. 14, it would be necessary merely to provide an opening 100 in the area of the chamber unit 46 shown on the right. Here, too, it is then also advantageous to design the separating piston 48 assigned to this chamber unit 46 in the same way as done for the chamber unit 46 situated on the left.

It should also be noted in conclusion that, in the case of the examples described above, the assignments of the first pressure chambers intended to act in the push state and of the second pressure chambers intended to act in the pull state represent merely examples. The assignments could obviously also be reversed. In should also be obvious that the number of pressure chambers in question could be larger or smaller. It would also be possible to provide one or several pressure chambers for only one direction of relative rotation; these chambers would then cooperate with one or more chamber units to fulfill the damping function. If a damping function is to be provided only in the pull direction, these could be the pressure chambers 34″, 34′. No incompressible damper fluid would then be present in the other pressure chambers, i.e., in this case the pressure chambers 32′ and 32″. These could be filled with air and be provided with compensating openings, so that essentially no force is provided for relative rotation. Here, too, of course, the arrangement could also be different, so that only the pressure chambers 32′ and 32″ contribute to the damping effect.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-16. (canceled)

17. A torsional vibration damper arrangement for a drive train of a motor vehicle, comprising:
a primary side,
a secondary side coupled to the primary side for rotation about an axis of rotation; and
a damper fluid arrangement configured to couple the primary side to the secondary side with relative rotation with respect to each other, the damper fluid arrangement comprising
a first damper fluid chamber arrangement;
a first damper fluid of a first compressibility in the first damper fluid chamber arrangement;
a second damper fluid chamber arrangement, the second damper fluid arrangement comprises a plurality of cylindrical chamber units arranged in a row around at least one of a circumference radially outside the first damper fluid arrangement and a circumference radially inside the first damper fluid arrangement;
a second damper fluid of second compressibility in the second damper fluid chamber arrangement, the second damper fluid being put under load when a pressure of the first damper fluid in the first damper fluid chamber arrangement increases, the second compressibility being greater than the first compressibility; and
a separating element assigned to each of the plural chamber units configured to separate the first damper fluid from the second damper fluid and further configured to be displaced radially when a pressure in the plural cylindrical chamber units changes.

18. The torsional vibration damper arrangement according to claim 17, wherein the separating element is configured as a separating piston.

19. The torsional vibration damper arrangement according to claim 17, wherein the first damper fluid chamber arrangement is configured as a ring-like structure, and the chamber units of the second damper fluid chamber arrangement are configured in a star-like configuration around the axis of rotation.

20. The torsional vibration damper arrangement according to claim 17, wherein the chamber units of the second damper fluid chamber arrangement are arranged radially outside the first damper fluid chamber arrangement.

21. The torsional vibration damper arrangement according to claim 17, wherein the chamber units of the second damper fluid chamber arrangement are arranged radially inside the first damper fluid chamber arrangement.

22. The torsional vibration damper arrangement according to claim 17, wherein the first damper fluid chamber arrangement comprises at least one first pressure chamber, a volume of the at least one first pressure chamber configured to be reduced upon relative rotation of the primary side relative to the secondary side in a first direction of relative rotation; and which is in working connection with at least one of the plural cylindrical chamber units of the second damper fluid chamber arrangement via a first connecting chamber.

23. The torsional vibration damper arrangement according to claim 22, wherein the first damper fluid chamber arrangement comprises at least one second pressure chamber, a volume of the at least one second pressure chamber configured to be reduced upon relative rotation of the primary side relative to the secondary side in a second direction of relative rotation opposite the first direction of relative rotation,
the at least one second pressure chamber is in working connection with at least one of the plural cylindrical assigned chamber units of the second damper fluid chamber arrangement via a second connecting chamber.

24. The torsional vibration damper arrangement according to claim 23, wherein at least one of the at least one first pressure chamber and the at least one second pressure chamber extend in the circumferential direction, and in that the respective first and second connecting chamber is arranged on the same radial side as the second damper fluid chamber arrangement is arranged relative to the first damper fluid chamber arrangement.

25. The torsional vibration damper arrangement according to claim 22, wherein
one of the primary side and the secondary side, comprises a first essentially cylindrical chamber housing; and
the other of the primary side and the secondary side, comprises a second cylindrical chamber housing configured to be inserted into the first cylindrical chamber housing and cooperates with it to form the boundaries of an annular space;
at least one first circumferential boundary projection extending toward the second chamber housing is provided on the first chamber housing;
at least one second circumferential boundary projection extending toward the first chamber housing is provided on the second chamber housing; and
the first pressure chamber is bounded in the circumferential direction between the first circumferential boundary projection and the second circumferential boundary projection, and a volume of the pressure chamber is variable through the relative circumferential movement of the circumferential first and second boundary projections forming its boundaries.

26. The torsional vibration damper arrangement according to claim 23, wherein at least one cylindrical chamber unit of the second damper fluid chamber arrangement assigned to a first pressure chamber of the first damper fluid chamber arrangement is in pressure-equalizing connection with at least one other chamber unit of the second damper fluid chamber arrangement which is assigned to a second pressure chamber of the first damper fluid chamber arrangement.

27. The torsional vibration damper arrangement according to claim 23, wherein a number of cylindrical chamber units of the second damper fluid chamber arrangement assigned to a first pressure chamber of the first damper fluid chamber differs from the number of cylindrical chamber units of the second damper fluid chamber arrangement assigned to the second pressure chamber of the first damper fluid chamber arrangement.

28. The torsional vibration damper arrangement according to claim 22, wherein the number of cylindrical chamber units of the second damper fluid chamber arrangement assigned to a first pressure chamber of the first damper fluid chamber arrangement differs from the number of cylindrical chamber units of the second damper fluid chamber arrangement assigned to another first pressure chamber of the first fluid chamber arrangement.

29. The torsional vibration damper arrangement according to claim 23, wherein the number of cylindrical chamber units of the second damper fluid chamber arrangement assigned to a second pressure chamber of the first damper fluid chamber arrangement differs from the number of cylindrical chamber units of the second damper fluid chamber arrangement assigned to another second pressure chamber of the first damper fluid chamber arrangement.

30. The torsional vibration damper arrangement according to claim 17, wherein a volume expansion for the second damper fluid is assigned at least to one cylindrical chamber unit of the second damper fluid chamber arrangement.

31. The torsional vibration damper arrangement according to claim 30, wherein the volume expansion comprises a volume enclosed between two circumferentially adjacent cylindrical chamber units of the second damper fluid chamber arrangement.

32. The torsional vibration damper arrangement according to claim 17, wherein the first damper fluid chamber arrangement is configured to be coupled to a source for the first damper fluid via a rotary leadthrough.

33. The torsional vibration damper arrangement according to claim 32, wherein the source of the first damper fluid is a reservoir for the first damper fluid.
